(19) United States
(12) Patent Application Publication
(10) Pub. No.: US 2007/0205027 A1
(43) Pub. Date: Sep. 6, 2007

(54) Scooter-driven staging system

(76) Inventor: Dale Snellenberger, Manchester, CT (US)

Correspondence Address: IRA S. DORMAN, 330 ROBERTS STREET, SUITE 200, EAST HARTFORD, CT, 06108, US

(21) Appl. No.: 11/365,535

(22) Filed: Mar. 1, 2006

(51) Int. Cl. B62D 51/04

(52) U.S. Cl. 180/19.1

(57) ABSTRACT

A mobile staging system includes a readily movable framework and a motor-driven scooter joined to one another for relative pivotable movement. Means for controlling movement of the scooter is readily accessible from a worker's platform on the staging.

### BACKGROUND OF THE INVENTION

It is frequently necessary to move staging, of the kind used for example by painters, from place-to-place about a job site. The need to dismount the staging for repositioning it is time-consuming and inconvenient, and can present a risk of injury.

### SUMMARY OF THE INVENTION

It is the broad object of the present invention to provide a staging system that is readily driven from place-to-place without requiring a worker to dismount the staging platform.

Other objects of the invention are to provide such a staging system that is safe, reliable, efficient, convenient, easy to operate, incomplex, and facile and economic to manufacture.

It has now been found that the foregoing and related objects of the invention are attained by the provision of a mobile staging system comprised of mobile staging, a motor-driven scooter, and means for coupling the staging and the scooter for relative pivotal movement on a generally vertical axis. The staging includes a framework having surface-engaging means, for enabling facile movement upon a floor or other surface, and provides a generally horizontal worker's platform. Means for controlling movement of the scooter comprises handle structure that is generally vertical in normal operation, nd the means for coupling serves to maintain the scooter in a substantially upright position while also locating the means for controlling so as to afford ready access to a worker from the worker's platform.

The surface-engaging means on the mobile staging will normally comprise a plurality of wheels. A first pair of wheels, disposed on a rear portion of the framework, will desirably take the form of casters, and a second pair of wheels, also desirably taking the form of casters, will usually be disposed on the front portion of framework; disengageable means will advantageously be provided for temporarily fixing the rear pair of casters against swiveling to thereby ensure travel along a straight path. It will be appreciated that surface-engaging means other than wheels, casters and rollers may be employed, such as runners, low-friction pads or discs, and the like.

The means used for coupling the staging to the scooter will preferably comprise a first tubular member, affixed to the framework of the staging, and a second tubular member affixed to the scooter, the tubular members being interengaged for pivotal movement relative to one another, most desirably in a telescopic interrelationship. The means for controlling movement of the scooter will usually include handle structure and a hand-operated brake mechanism, the latter consisting of a brake element that is movable between off and on positions for applying braking force to the scooter in the on position, and brake-operating means on the handle structure for moving the brake element to the on position; means for maintaining the brake element in the on position will desirably also be provided.

The scooter will preferably have an electric drive system comprised of an electric motor and circuitry operatively connecting the motor to a power supply (e.g., an on-board battery). The means for controlling movement will advantageously include a reversing switch, located on the handle structure and operatively connected in the electrical circuitry for selectively energizing the motor to drive the scooter in either a forward direction or a rearward direction (such as by reversing the polarity of direct current supplied).

### BRIEF DESCRIPTION OF THE DRAWINGS

FIG. 1 is a perspective view of a mobile staging system embodying the present invention, a portion of the scooter body floor panel being broken away to expose internal features;

FIG. 2 is perspective view of a portion of the anti-castering alignment bracket employed in the system of FIG. 1; and

FIG. 3 is a diagrammatic elevation view of the brake arrangement provided on the scooter employed in the system.

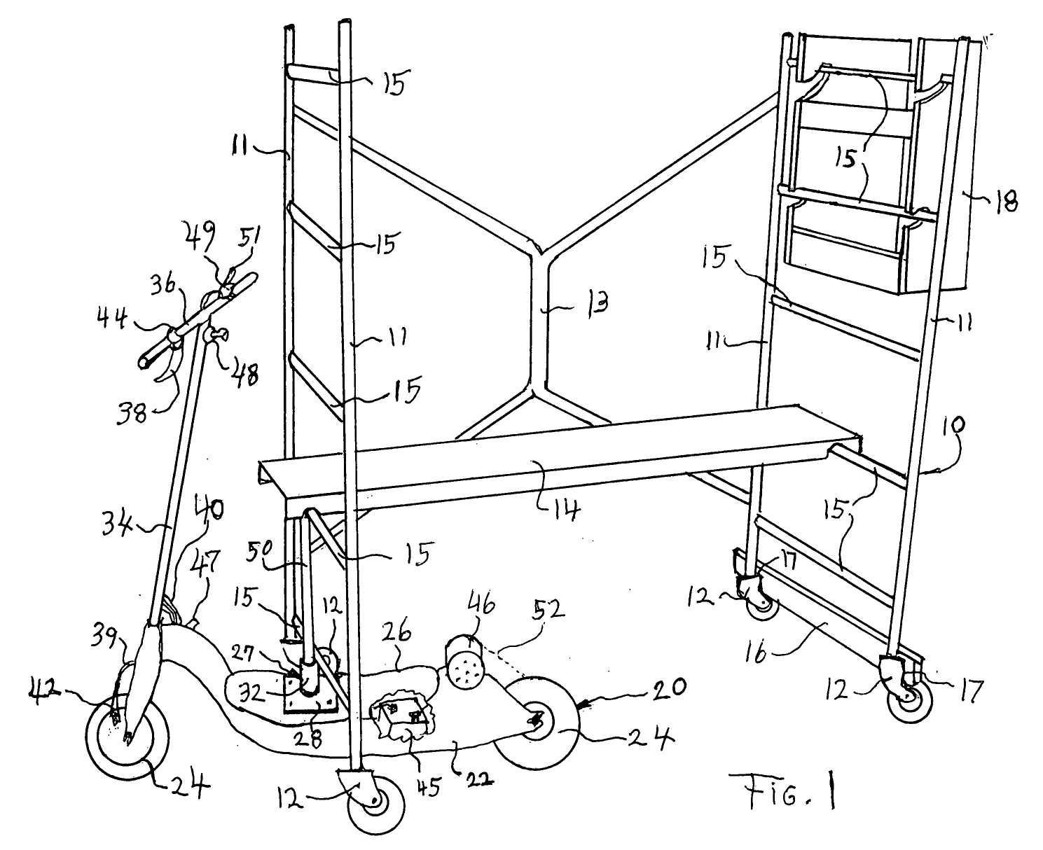

### DETAILED DESCRIPTION OF THE PREFERRED AND ILLUSTRATED EMBODIMENT

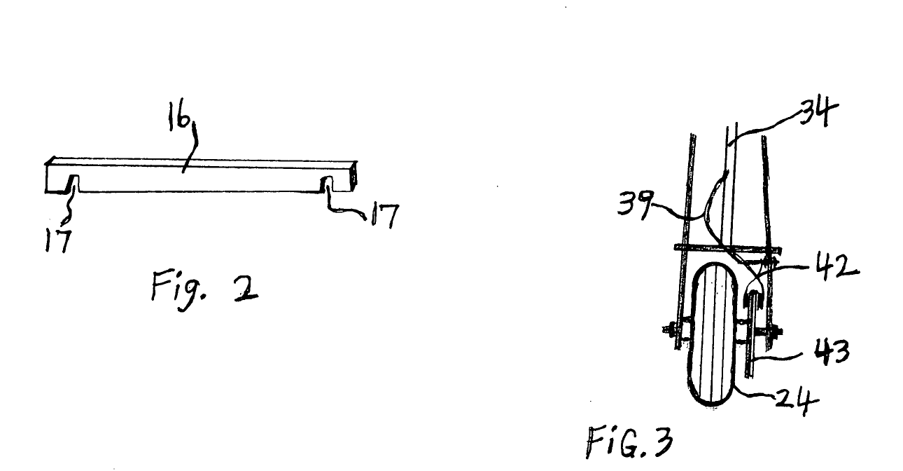

Turning now in detail to the appended drawings, therein illustrated is a mobile staging system embodying the present invention and including a framework, generally designated by the numeral 10 and consisting of four (normally vertical) corner legs 11, five crosspieces 15 extending horizontally between each pair of legs (i.e., perpendicularly thereto) located at the front and rear of the framework, and a center brace 13. A swiveling wheel, or caster, 12 is attached at the bottom of each of the legs 11, and an anti-castering alignment bracket, or locking bar, 16 (separately shown in FIG. 2) is attached over the two wheels 12 at the rear of the framework 10. The bracket 16 is notched at two spaced locations to provide generally rectangular indentations 17 for receipt of the rear wheels 12, and its function is to keep those wheels straight and prevent the staging from fishtailing or swinging excessively when turning; the bracket 16 also cooperates in locking the wheels for safety purposes. A removable shelf or storage box 18 is built with downwardly directed hook structures by which it is hung from two of the cross-pieces 15 so as to provide a readily removable and convenient storage place for tools, supplies, and the like.

The scooter, generally designated by the numeral 20, is a commercial machine comprised of an elongate body or chassis 22 having wheels 24 at its opposite ends and providing or supporting a footboard or floor panel 26 therebetween. A mounting bracket, generally designated by the numeral 27, includes a fastening plate 28 by which it is attached on top of the footboard 26 and from which projects an upright cylindrical tubular socket 32, the function of which will be described below. It will be appreciated that the tires used on the wheels 24 will advantageously be both puncture proof and also anti-marking, given the nature of the environment (e.g., tile or wooden flooring, and the like) in which the staging system of the invention would typically be employed.

The handle structure provided on the scooter includes a substantially upright post 34 and a crosswise handlebar 36. Although not described in detail, it will be appreciated that the post 34 is attached to the chassis 22 through an assembly that permits the handle structure to be collapsed downwardly toward the footboard 26 so as to reconfigure the scooter for easy storage and transport.

A hand-brake assembly 38 is mounted on the handlebar 36 and is attached by a mechanical cable 39 for operation of a brake mechanism 42 (best seen in FIG. 3), which serves to retard and arrest rotation of the front wheel 24, in its “on” position, through engagement with brake pads or other members (not shown) brought to bear upon a brake disc 43 by operation of a conventional caliper arrangement. A spring-biased brake-locking pin 44 (only the outer end of which is visible) is also installed in the handlebar 36 and is constructed to disengageably secure the lever of the brake assembly 38 in position for maintaining braking force upon the scooter wheel 24 and thereby for preventing movement of the staging (advantageously in cooperation with the rear wheel alignment bracket 16); squeezing force upon the lever of the brake assembly 38 effects automatic release of the pin 44.

An on-board battery 45 (e.g., a 12-volt rechargeable battery) is stowed beneath the floor panel 26 and conveniently serves as the power supply for the drive motor 46, which is operatively connected to the rear wheel 24 by a drive chain 52; the battery 45 is charged through the terminal connector 47. A key-operated reversing switch 48, and a speed-control unit 49, are mounted on the handlebar 36 and are connected in the motor circuit through electrical cables 40. The switch 48 functions to effectively reverse the polarity of the electrical current delivered to the motor 46 from the battery 45, and thereby to enable the scooter to be driven, selectively, in either a forward direction or a rearward direction; the speed-control unit 49 is effectively a rheostat, adjustable through operation of the lever 51 for varying the amount of electric current delivered to the motor.

A cylindrical vertical coupling shaft 50 is attached to one of the crosspieces 15 at the front of the framework 10. The lower end of the shaft 50 is telescopically received in the upstanding cylindrical tubular socket 32 of the mounting bracket 27, thereby coupling the scooter 20 and framework 10 for relative pivotable movement on a generally vertical axis; obviously, the relationship of telescopic interengagement can be reversed, and other functionally equivalent coupling arrangements can be substituted. It will be appreciated that the construction and weight of the framework 10 are alone sufficient to maintain the coupling shaft 50 securely engaged in the socket 32 of the mounting bracket 27, while imposing little if any added load upon the scooter 20 and permitting both the scooter and the staging 10 to move and maneuver freely.

The assembly of the shaft 50 and the bracket 27 also serves the additional purpose of maintaining the scooter in an upright orientation without added support, thus keeping the handle structure readily accessible to a worker from the platform 14, who needs only reach forwardly to grasp the handlebar 36. Because the handlebar 36, the brake lever assembly 38, the reversing switch 48, and the speed-control unit 49 are all within the easy reach of the worker, direction and speed of movement, braking, steering, and other operating functions are readily controlled for optimal operation of the staging system and maximum safety to the worker.

It will be appreciated that many variations, in addition to those mentioned above, may be made in the system of the invention without departure from the concepts hereof. Obviously, the construction and configuration of the staging framework can vary widely, as can its manner of coupling to the scooter (e.g., a rotatable bearing assembly might be substituted). The operating features of the scooter may also vary, and indeed, while a battery-powered, electrically-driven scooter will normally be preferred (for obvious reasons), AC line-powered and gas-powered machines may be employed if so desired, with suitable changes being made of course in the incorporated control features.

Thus it can be seen that the present invention provides a novel staging system that is readily driven from place-to-place without requiring a worker to dismount the staging platform. The system is safe, reliable, efficient, convenient, easy to operate, incomplex, and facile and economic to manufacture.

Having thus described the invention, what is claimed is:

1. A mobile staging system, including: mobile staging comprised of a framework having surface-engaging means for enabling facile movement of said framework upon a support surface, and a generally horizontal worker's platform on said framework; a motor-driven scooter having means for controlling movement of said scooter, said means for controlling movement comprising handle structure that is generally vertical in normal operation of said scooter; and means for coupling said staging and said scooter for relative pivotal movement of said staging and scooter on a generally vertical axis and for maintaining said scooter in a substantially upright position with said means for controlling accessible to a worker from said worker's platform.

2. The staging system of claim 1 wherein said surface-engaging means comprises a plurality of wheels.

3. The staging system of claim 2 wherein said means for joining comprises structure disposed on a front portion of said framework, and wherein a first pair of said wheels are disposed on a rear portion of said framework, spaced from said front portion.

4. The staging system of claim 3 wherein said wheels of said first pair are casters, and wherein said staging additionally includes disengageable means for temporarily fixing said casters against swiveling and for travel along a straight path.

5. The staging system of claim 3 wherein a second pair of said wheels are disposed on said front portion of said framework.

6. The staging system of claim 1 wherein said means for joining comprises a first member affixed to said framework of said staging and a second member affixed to said scooter, said first and second members being interengaged for pivotal movement relative to one another.

7. The staging system of claims 6 wherein said first and second members are cylindrical, are oriented on an axis that is normally generally vertical, and are telescopically interengaged, at least one of said first and second members being tubular.

8. The staging system of claim 7 wherein said means for joining is devoid of additional means for maintaining said first and second members in assembly with one another.

9. The staging system of claim 1 wherein said means for controlling movement of said scooter comprises a hand-operated brake mechanism, including a brake element that is movable between an off position and an on position for applying braking force to said scooter in said on position, and brake-operating means on said handle structure for moving said brake element to said on position.

10. The staging system of claim 9 wherein said brake mechanism also includes means for maintaining said brake element in said on position.

11. The staging system of claim 1 wherein said scooter includes an electric drive system comprised of an electric motor and circuitry for operatively interconnecting said motor to a power supply; and wherein said means for controlling movement includes a reversing switch located on said handle structure and operatively connected in said circuitry for selectively energizing said motor to drive said scooter in either a forward direction or a rearward direction.
